(19) United States
(12) Patent Application Publication
(10) Pub. No.: US 2015/0357070 A1
(43) Pub. Date: Dec. 10, 2015

(54) NANOSTRUCTURES AND ASSEMBLY OF NANOSTRUCTURES

(71) Applicant: EMPIRE TECHNOLOGY DEVELOPMENT, LLC, Wilmington, DE (US)

(72) Inventor: Peter John Reece, Blaxland (AU)

(21) Appl. No.: 14/301,186

(22) Filed: Jun. 10, 2014

(51) Int. Cl. G21K 5/02; G21K 1/16; B01J 19/12; B05D 3/06; B05C 9/12

(52) U.S. Cl. CPC G21K 5/02; B05D 3/06; B05C 9/12; B01J 19/121; G21K 1/16

(57) ABSTRACT

Examples are described related to nanostructures and assembling nanostructures. A fluid including nanostructures may be deposited onto a surface of a substrate. Optical beams may be directed towards a region of the surface of the substrate such that the optical beams overlap at a location within the region. Radiation pressure generated by the optical beams may effectively drive at least some of the nanostructures in the fluid towards the substrate. In this manner, the nanostructures may be assembled on the substrate.

### BACKGROUND

Nanostructures may be utilized in a variety of electronic elements.

Examples of existing techniques for assembling nanostructures include Langmuir Blodgett techniques. These techniques utilize surface adhesion forces experienced when a substrate is drawn through a liquid interface. Other examples are microfluidic based assembly techniques utilizing flow fields and surface tension generated in microfluidic channels or droplets to orient nanostructures. Unless otherwise indicated herein, the materials described in this section are not prior art to the claims in this application and are not admitted to be prior art by inclusion in this section.

### SUMMARY

Techniques are generally described that include methods and optical systems. Some example methods include assembly methods. An example assembly method may include depositing fluid including nanostructures onto a substrate. The method may further include directing optical beams onto the substrate such that the optical beams overlap at a location on the substrate, wherein at least a portion of the fluid is present at the location, and radiation pressure generated by the optical beams effectively drives at least some of the nanostructures in the fluid towards the substrate. In this manner the nanostructures may be assembled on the substrate.

Nanostructures may include solid, partially solid, hollow structures, or combinations thereof having at least one dimension less than about 1 micron in extent. Nanostructures may include elongated nanostructures, such as nanowires and nanotubes, and other elongated shaped forms such as prolate shaped forms. Nanostructures may also include other forms, including irregular shapes. Nanostructures may include metal, semiconductor, dielectric, organic, and/or biological nanowires. In some examples, nanostructures may comprise an electrically conducting material, such as a metal, a semi-metal, or a semiconductor. Nanostructures may have various characteristics such as an anisotropic optically polarizable characteristic, where the nanostructures may be physically aligned using an optical field. In some examples, nanostructures may include spatially, optically, and/or electrically anisotropic structures. In some examples, nanostructures may include nanowires, nanotubes, nanodisks and the like.

In some examples, nanostructures are nanowires. Nanowires may comprise electrically conducting materials, semiconducting materials, or electrically insulating materials. Example nanowires may include metal nanowires, semiconductor nanowires, semi-metal nanowires, and dielectric nanowires. In some examples, nanowires may include polymer nanowires or biological nanowires, such as virus particles. In some examples, nanowires may be dielectric nanowires, and may comprise an electrically insulating material. Nanowires may be nanorods, having a solid, partially solid, hollow, or combinations thereof, elongated form with substantially flat, rounded, elliptical, or chamfered ends. Nanowires may be effectively cylindrical, or may have a cross-sectional profile that is substantially round, oval, elliptical, or some other geometric form which may be regularly or irregularly shaped. As used herein, nanowires and nanorods do not necessarily include nanotubes such as carbon nanotubes.

In some examples, nanostructures are nanotubes, such as metal nanotubes, semiconductor nanotubes, or other nanotubes such as carbon nanotubes.

In some examples, nanostructures are nanodisks or other substantially flattened structures.

An example optical system may include a beam splitter device and an optical director. The beam splitter device may be configured to split an incoming optical beam into two or more optical beams. The optical director may be arranged to direct the two or more optical beams to overlap at a location of fluid on the substrate such that radiation pressure generated by the optical beams effectively drives at least some of the nanostructures in the fluid towards the substrate at the location. In this manner the nanostructures may be assembled on the substrate by the optical system.

In some examples, an optical director may be configured to receive two or more optical beams and direct the optical beams towards the substrate. The optical director may include optical elements, such as lenses, and the optical elements may be controllable to dynamically direct the optical beams towards a desired location on the substrate.

Some example substrates may comprise a metal, semiconductor, polymer, glass, ceramic, and/or some other material. In some examples, a substrate may be planar substrate. In some examples, a substrate may include an electronic circuit, for example where nanostructures are positioned within an electronic circuit.

Another example method includes generating two or more optical beams. The method further includes directing the two or more optical beams to substantially overlap at a location of nanostructures in a fluid on a substrate. The method may further include adjusting a spatial pattern associated with overlap of the two or more optical beams about the location of nanostructures on the substrate. Radiation pressure can be applied to the nanostructures effective to drive the nanostructures toward the location about the substrate, and gradient forces can be applied to the nanostructures such that the gradient forces orient the nanostructures in accordance with the spatial pattern.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a flowchart illustrating an example assembly method;

FIG. 2 is a schematic illustration of a cross-section of a substrate, fluid including nanostructures, and optical beams;

FIG. 3 is a schematic illustration of an optical system:

FIG. 4 is a schematic illustration of a portion of an optical system including a translation stage;

FIG. 5 is a flowchart illustrating an example method for nanostructure assembly;

FIG. 6 is a schematic illustration of a portion of an optical system;

FIG. 7 is a block diagram illustrating an example computing device that is arranged for positioning nanostructures in accordance with the present disclosure; and

FIG. 8 is a block diagram illustrating an example computer program product that is arranged to store instructions for positioning nanostructures in accordance with the present disclosure;

all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are implicitly contemplated herein.

This disclosure is drawn, inter alia, to methods, systems, products, devices, and/or apparatus generally related to nanostructures and assembling nanostructures. A fluid including nanostructures may be deposited onto a surface of a substrate. Optical beams may be directed towards a region of the surface of the substrate such that the optical beams overlap within the region. Radiation pressure generated by the optical beams may effectively drive at least some of the nanostructures in the fluid towards the substrate. In this manner, the nanostructures may be assembled on the substrate.

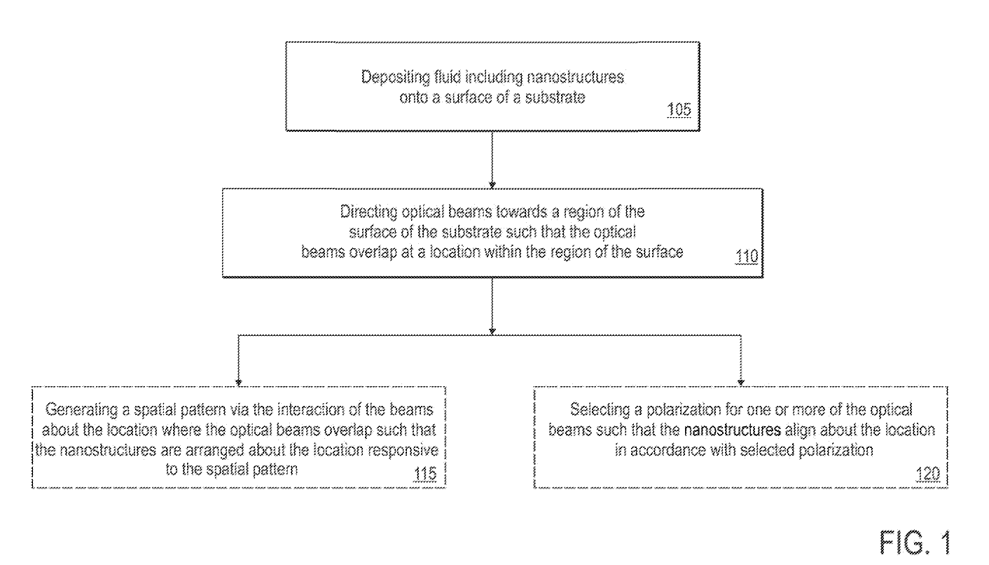

FIG. 1 is a flowchart illustrating an example assembly method that is arranged in accordance with at least some embodiments described herein. An example assembly method may include one or more operations, functions or actions as illustrated by one or more of blocks 105, 110, 115, and/or 120. The operations described in the blocks 105 through 120 may be performed in response to execution (such as by one or more processors described herein) of computer-executable instructions stored in a computer-readable medium, such as a computer-readable medium of a computing device or some other controller similarly configured.

An example process may begin with block 105, which recites “depositing fluid including nanostructures onto a surface of a substrate.” Block 105 may be followed by block 110, which recites “directing optical beams towards a region of the surface of the substrate such that the optical beams overlap at a location within the region of the surface.” Block 110 may be followed by block 115, which recites “generating a spatial pattern via the interaction of the beams about the location where the optical beams overlap such that the nanostructures are arranged about the location responsive to the spatial pattern.” Block 110 may also be followed by block 120, which recites “selecting a polarization for one or more of the optical beams such that the nanostructures align about the location in accordance with selected polarization.” Polarization may be varied with or without the generation of a diffraction pattern.

The blocks included in the described example methods are for illustration purposes. In some embodiments, the blocks may be performed in a different order. In some other embodiments, various blocks may be eliminated. In still other embodiments, various blocks may be divided into additional blocks, supplemented with other blocks, or combined together into fewer blocks. Other variations of these specific blocks are contemplated, including changes in the order of the blocks, changes in the content of the blocks being split or combined into other blocks, etc. In some examples, block 115 may occur simultaneously, or at least partially simultaneously, with block 110. In some other examples, block 120 may occur all or in part simultaneously with block 110

Block 105 recites, “depositing fluid, including nanostructures, onto a surface of a substrate.” and in some examples the nanostructures may be nanowires. Depositing the fluid may occur in block 105 using any suitable methodology, for example dispensing the fluid, spraying the fluid, and/or submerging the substrate in the fluid. In some examples, dispensers may be provided for expelling fluid including nanostructures onto the substrate.

Block 110 recites, “directing optical beams towards a region of the surface of the substrate such that the optical beams overlap at a location within the region of the surface.” Any number of optical beams may be used including 2 beams in some examples, 3 beams in some examples, 4 beams in some examples, and other numbers of beams in other examples.

The optical beams may interact to urge at least a portion of the nanostructures in the fluid towards the location with force generated by the optical beams within the region such that nanostructures are arranged in a desired location on the substrate.

Block 115 recites, “generating a spatial pattern via the interaction of the beams about the location where the optical beams overlap such that the nanostructures are arranged about the location responsive to the spatial pattern.” In some examples, block 115 may include adjusting a phase delay of one or more of the optical beams to control the spatial pattern.

Block 120 recites, “selecting a polarization for one or more of the optical beams such that the nanostructures align about the location in accordance with selected polarization.” In some examples, block 120 may be used for aligning nanowires (such as semiconductor or metal nanowires or nanotubes (e.g., carbon nanotubes) having dimensions less than about 1 micron and diameters less than about 10 nanometers. Other dimension nanowires may be used with block 120 in other examples.

Nanowires may include nanoscale materials having cross-sectional dimensions on the order of tens to hundreds of nanometers and lengths ranging from less than a micrometer to several hundred micrometers. Example nanowires may have a cross-sectional dimension (for example, a diameter for a cylindrical nanowire) in a range of about 1 nm to about 1 micron and a length in a range of about 10 nm to about 500 microns. Example nanowires may have a cross-sectional dimension (for example, a diameter for a cylindrical nanowire) in a range of about 1 nm to about 500) nm and a length that is at least ten (10) times the cross-section dimension, in some examples at least twenty (20) or fifty (50) times the cross-section dimension. Nanowires may refer to nanoscale materials having an aspect ratio of about 10:1 or larger, about 15:1 or larger in other examples, about 20:1 or larger in other examples, about 50:1 or larger in other examples, or about 100:1 or larger in other examples. Nanowires may be implemented using any of a variety of materials including, but not limited to, semiconductor materials, metallic materials, or dielectric materials. Nanowires may be implemented using carbon nanotubes in some examples. Nanowires may be implemented using silicon in some examples. Nanowires may be implemented using III-V compound materials, such as gallium arsenide, in some examples.

In some examples, methods, systems, and devices described herein may be used for assembly of other nanostructures including, but not limited to, quantum dots, nanorods, nanotubes, nanowires, or other nanoscale particles. Examples described herein that pertain to the orientation of nanowires may generally be used with nanostructures for which a particular orientation may be desirable.

Substrates usable with examples of the presently disclosed technology include transparent, opaque, and reflective substrates. For example, semiconductor substrates (such as silicon substrates), metallic substrates, or plastic substrates may be used. In some examples, the substrate may include all or a portion of an electronic or optical component. Examples described herein may assemble nanowires to a particular location of the substrate such that the nanowire may form an integral part of the electronic or optical component. Examples of such electronic or optical components include, but are not limited to, circuits (e.g., VLSI circuits), light emitting diodes, photo-detectors, transistors, sensors, actuators, transducers, and solar cells.

Any of a variety of suitable fluids that include nanostructures may be used in the above described methods. Example fluids include, but are not limited to liquids such as aqueous solutions, water, and buffer fluids. A buffer fluid may, for example, have a pH selected to minimize interactions with the nanostructures or other components in the fluid. The fluid may include and/or be implemented using a solvent. Solvents which may be used include, but are not limited to, ethanol, methanol, acetone, DMSO, and combinations thereof. Generally, a fluid may be selected where the components are miscible and the fluid is not strongly absorbing at the optical energy wavelength or wavelengths used for nanostructure manipulation. In some examples, viscous solvents (e.g. glycerol) may be used to reduce or suppress Brownian or other motion of nanostructures, which may improve alignment accuracy in some examples. Nanostructures may be suspended in or otherwise present in the fluid. Nanostructures maybe surface functionalized to facilitate suspension.

In some examples, nanostructures, such as nanowires, may be grown on another substrate using any appropriate technique, for example, metalorganic vapor phase epitaxy (MOVPE) or metalorganic chemical vapor deposition (MOCVD). For example, the nanostructures may be grown perpendicular to the substrate using these or other techniques. The nanostructures may then be removed from the substrate on which they were grown using any appropriate method, such as a physical and/or chemical mechanism. Examples include, but are not limited to, sonication or use of a sacrificial release layer present on the substrate on which the nanowires were grown and later etched or otherwise removed to release the nanostructures. In this manner, nanostructures may be removed from a substrate on which they were grown and introduced to a fluid, for example as a solution or suspension.

The fluid including nanostructures may cover the substrate surface or may be present in a particular area of the substrate surface (e.g., one or more droplets or other shapes on the substrate surface).

Directing the beams in some examples may include focusing the beams onto the substrate. Directing the beams in some examples may include collimating the beams and directing the beams at the substrate. In some examples the beams may be oriented at an angle with respect to the substrate. In one example, two counter propagating beams may be used that may be weakly focused at an oblique angle (e.g. not perpendicular) to the substrate. Oblique angles may in some examples facilitate use with an inspection microscope. In some examples, the beams may have equal intensities. In other examples the beams may have unequal intensities. In some examples, some beams may have equal intensities while others have unequal intensities. The intensities of the beams may be used to adjust particular locations on the substrate at which nanostructures may be assembled. In some examples, the beams may be directed onto the surface at identical angles to the surface. In other examples, one or more of the beams may be directed onto the surface at angles that differ from one or more of the other beams.

The beams may overlap at a location on the substrate (e.g., a spot on the substrate). The location may generally take any shape including, but not limited to, circular, non-circular, more amorphous (e.g., irregular shape). The size of the location may be adjusted by, for example, adjusting an exit pupil of a spatial light modulator (SLM) used to generate one or more of the optical beams. In some examples having a circular location, the location may be up to about 0.5 mm in diameter using a 1 W infrared laser to generate the optical beams. In other examples, other diameters of locations at which optical beams overlap may be used. Sizes of up to about 0.6 mm may be used in some examples, up to 0.8 mm in some examples, up to 1 mm in some examples. Generally, diameters of circular locations at which optical beams overlap may range from 100 s of microns through millimeters in some examples. In other examples, larger diameters may be achieved by increasing the power of a laser used to generate the optical beams (e.g., using a continuous wave laser of up to 100 W in some examples, including using fiber lasers). In some examples, for an elliptical spot of 100 μm by 250 μm, an input power of larger than 100 mW may produce significant aggregation. This configuration may generate about 125 W/cm² at the location of overlap. This could easily be an order of magnitude smaller or larger in other examples depending on the details of the scattering properties of the nanostructures.

The beams may be directed onto the substrate such that the overlap at a location at which at least a portion of the fluid including nanostructures is present. The beams may be arranged in an epi-illumination configuration in some examples for use with a variety of substrate types including transparent, opaque, and reflective. The beams generally generate radiation pressure to drive at least some of the nanostructures toward the substrate, to assemble the nanostructures (e.g., place the nanostructures onto the substrate). Generally, radiation pressure may drive nanostructures towards a surface of a substrate. Anisotropic nanostructures (e.g., nanowires) may be aligned using spatial patterns, such as diffraction patterns, and/or polarization, examples of which are also described.

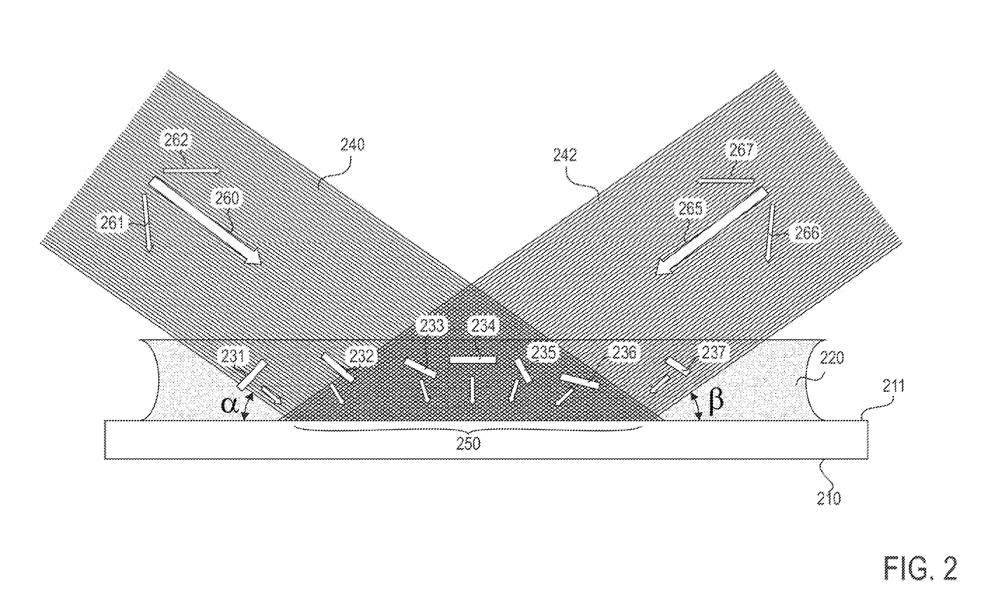

Being at an angle to the substrate, the beams may generate radiation pressure in a first direction (e.g., toward the substrate) and in a second, orthogonal direction (e.g., across the substrate). Beams may generally be directed at angles ranging from 30 to 60 degrees with respect the normal. Angles outside of this range are also possible, however this may lead to a substantially uneven distribution of power between the lateral and normal radiation pressures. Through the use of multiple beams, the forces in the second direction (e.g., across the substrate) may be balanced such that nanostructures are driven toward a predetermined position within the location, where that predetermined position may be determined by the magnitude of the radiation forces generated by the beams across the substrate. For example, the predetermined position may be determined by respective intensities of the optical beams. The predetermined position may be a central position, e.g., a center, in some examples. The size of the location (e.g., a blob) may not lend itself to a center, and other predetermined positions may be used. In some examples, the nanostructures may have a high refractive index compared to standard dielectric objects and the optical force generated by the radiation pressure may be relatively high. Further discussion regarding examples of the radiation forces is provided below with reference to FIG. 2.

A spatial light modulator may be used to encode a phase pattern in one or more of the optical beams such that when passed through a focusing lens, a diffraction pattern may be generated at the substrate surface. The diffraction pattern may affect local gradient forces generated by radiation pressure provided by the optical beams. In this manner, nanoparticles may be assembled to locations dictated in part by the diffraction pattern. In some examples, encoding a phase pattern may include adjusting a phase delay of one or more of the optical beams to control the diffraction pattern. A phase delay may be applied to a portion of the spatial light modulator to control a position of the diffraction pattern fringes with respect to the substrate. In some examples, encoding a phase pattern may include varying a phase delay across a cross-section of one or more optical beams.

Moreover, nanowires may orient themselves in accordance with the diffraction pattern. For example, the long axis of the nanowires may be aligned to the orientation of fringes in the diffraction pattern. This effect may be increased as the intensity of one or more of the optical beams is increased. This effect may be facilitated by nanowires which have a strong shape birefringence. Complex diffraction patterns may be used to facilitate complex two-dimensional assembly in some examples.

When nanostructures have been driven to desired location(s) under the influence of the radiation pressure provided by the optical beams, the intensity of one or more of the optical beams may be increased to drive the nanostructures to the surface. Once driven toward the surface, the nanostructures may adhere to the surface, for example through Van der Waals forces. A rinse may be performed to remove unbound nanostructures and fluid in some examples. The Van der Waals forces may be sufficient to hold the nanostructures on the surface during a rinse in some examples.

In some examples, a secondary focused laser beam may be used to raster across the substrate and bond the assembled nanostructures to the surface. For example, two or more beams may be used to align nanostructures at one or more locations on the substrate. After locating the nanostructures, a bonding laser beam may be used to bond the assembled nanostructures to the substrate. For example, the bonding laser beam may be rastered over the substrate. The bonding laser beam may be normal, or approximately normal, or oblique to the substrate. The bonding laser beam may have a different wavelength to the laser beams used to position the nanostructures, for example having a longer or shorter wavelength. A longer wavelength may be used, as positional accuracy may no longer be as important as the nanostructures may be already positioned with desired spatial accuracy. In some examples, the bonding laser beam may be used to induce a chemical reaction between functional groups on the nanostructure and substrate respectively. For example, a shorter wavelength, such as blue or UV, bonding laser beam may be used to induce chemical bonding to the substrate, for example using an induced photoreaction. In some examples, a pulsed laser beam may be used as the bonding laser beam. One or more of the optical beams, and/or the bonding laser beam, may be rastered in a stepped manner across the substrate to create an arrangement, such as an array, of nanostructures on the substrate.

In some examples, the fluid containing the nanowires may be selected to have a low surface tension to aid in the adhesion of the nanowires to the substrate. For example, a surfactant may be included in an aqueous solution, or a liquid with lower surface tension used.

Polarization orientation may be controlled in different regions of the location in which the optical beams overlap. A spatial light modulator may be configured to vary the polarization of one or more of the optical beams to achieve the varied polarization at the location. Nanowires may align with the polarization location. In some examples, the precise position of the nanowires may be less defined since Brownian motion may be more severe, and the intensity gradients of the radiation pressure may be significantly larger than the nanowire dimensions.

FIG. 2 is a schematic illustration of a cross-section of a substrate, fluid including nanostructures, and optical beams, arranged in accordance with at least some embodiments described herein. The substrate may be implemented using any suitable substrates, examples of which have been described above. FIG. 2 shows substrate 210, surface 211, fluid 220, nanowires 231, 232, 233, 234, 235, 236, and 237, optical beam 240, second optical beam 242, and location 250 where the optical beams 240 and 242 substantially overlap.

The fluid 220 is illustrated including nanowires 231-237. The optical beams 240 and 242 overlap at location 250 on the substrate 210.

The figure shows the optical beams being directed at the substrate from locations not shown on the figure, each beam is incident on the substrate after passing through a portion of the fluid. The fluid is present as a fluid film on the substrate. The optical beams may be considered to provide a force in a direction along the direction of the beam. Those forces may be represented as a lateral force portion and a perpendicular force portion, relative to the surface of the substrate. Where the beams overlap, the lateral portion of the forces provided by the optical beams may cancel out or be substantially reduced. Where the beams overlap, the perpendicular force portion may be added for the two beams. In portions of the fluid exposed to a single beam (e.g., in the non-overlapping portion), the lateral forces may tend to urge (e.g., direct) the nanostructures towards the overlap region.

Although seven nanowires are shown in FIG. 2, the fluid 220 may include any number of nanowires in other examples. Optical beams 240 and 242 are shown. Although two optical beams are shown in FIG. 2, any number may be used in other examples.

The optical beam 240 is illustrated as directed at the surface 211 of substrate 210 at an angle α with respect to the surface 211, and the optical beam 242 is illustrated as directed at the surface 211 of substrate 210 at an angle β with respect to the surface 211 of the substrate 210. The angles α and β may be substantially matched in some examples, and may be substantially different in other examples. In various examples, each of the angles α and β may be in a range from about 0 to about 90 degrees. In some examples, the angles α and β may be in a range from about 10 to about 80 degrees. In some examples, the angles α and β may be in a range from about 20 to about 70 degrees. In some examples, the angles α and β may be in a range from about 30 to about 60 degrees. In some examples, the angles α and β may be oblique angles, (e.g., different from 90 degrees) with respect to the surface 211 of substrate 210. In the example of FIG. 2, the surface 211 is planar. In some examples, a flexible, curved, or varied surface may be used. In examples of curved or varied surfaces, the described angles may be measured from a tangent line at a point on the surface where the surface profile changes.

Each of the optical beams 240 and 242 may be configured to exert forces on the nanowires 231-237 in the direction of the optical beams. In some examples, the optical beams 240 and 242 may generate radiation pressure that exerts forces on the nanowires 231-237, for example radiation pressure may be generated due in part to photons from one or more of the optical beams 240 and 242 striking the nanowires, imparting momentum to the nanowires. The radiation pressure, and resulting forces, may have one force component exerted towards the surface 211 of substrate 210 (e.g., substantially normal to the surface) and another force component exerted across the surface 211 of substrate 210 (e.g., towards a position within the location 250). For example, the beam 240 may generate a force 260 that is exerted on nanowires 231-236 (note that in the example of FIG. 2, the nanowire 237 is not exposed to the beam 240), while beam 242 may generate a force 265 that is exerted on nanowires 232-237 (note that in the example of FIG. 2, the nanowire 231 is not exposed to the beam 242).

The forces 260 and 265 may be expressed as vectors that each have components that vary according to their respective intensity level (e.g., I₁ and I₂) and angles (e.g., α and β). For example, a first force (e.g., F₁ or force 260) may include two force components that form a first orthogonal set; namely a first force component 261 exerted in a first direction towards the surface of the substrate 210 (e.g., substantially normal to a point on the surface), and a second force component 262 exerted in a second direction oriented in a same direction as the surface of the substrate 210 (e.g., substantially tangent to the point on the surface). Similarly, a second force (e.g., F₂ or force 265) may include two force components that form a second orthogonal set; namely a third force component 266 that is exerted in the third direction towards the surface of the substrate 210 and a fourth force component 267 that is exerted in an opposite direction with respect to the second direction. The forces can be represented mathematically as:

F₁=(I₁ cos(α)\hat{x},I₁ sin(α)\hat{y}), and F₂=(−I₂ cos(β)\hat{x},I₂ sin(β)\hat{y}),

using x and y coordinates, to which all examples are not so limited.

As can be appreciated based on the above discussion, the nanostructures may be dynamically urged towards a desired location at or within a location 250 of surface 211 by adjusting the intensities (e.g., I₁ and I₂) and angles (α and β) associated with beams 260 and 265. For example, when the competing forces 262 and 267 are substantially matched (e.g., when the intensities I₁ and I₂ are substantially equal and the angles α and β are substantially matched), then I₁ sin(α)=I₂ sin(β) such that the downward forces are matched, and I₁ cos(α)=I₂ cos(β) resulting in equal and opposite forces along the surface 211 of substrate 210, resulting in urging the nanostructures towards location 250 on the surface 211 of substrate 210. In other examples, the intensity of one or more of the beams 240 or 242 can be varied to urge the nanostructures to a different location. In still other examples, the angles alpha and beta may be varied to urge the nanostructures to still a different location. In yet further examples, a combination of varying intensity and angles can be utilized to urge the nanostructures towards another desired location.

In some examples, one or more of the optical beams may be oriented at angles in a third dimension with respect to a surface of a substrate, and forces provided by the beams may be considered to include three components—one perpendicular to a surface of a substrate, one along the surface of the substrate in a first direction (e.g., length) and one along the surface of the substrate in a second direction (e.g., width). The first and second directions along the surface may be perpendicular to one another. In this manner, nanostructures may be urged to a desired location in two dimensions along the surface (e.g., lengthwise and widthwise).

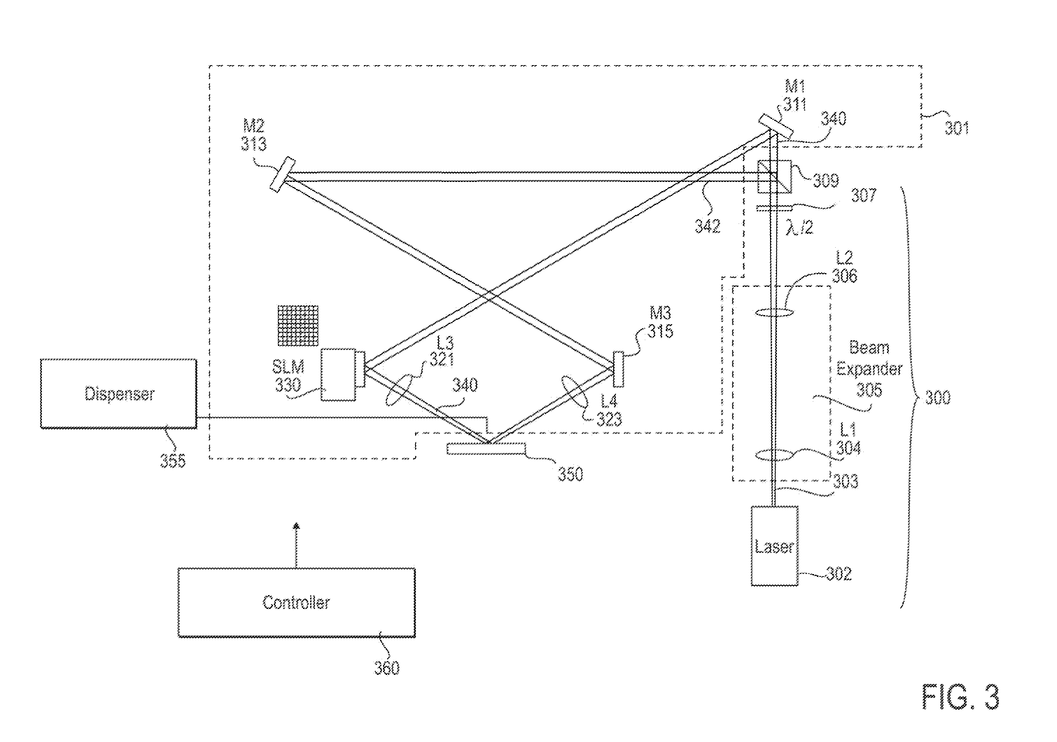

FIG. 3 is a schematic illustration of an optical system arranged in accordance with at least some examples of the present disclosure. FIG. 3 shows an optical beam generator 300, a beam splitter 309, an optical director 301, a substrate 350, a dispenser 355, and a controller 360. Optical beam generator 300 may include a laser 302. Optical beam generator 300 may also include a beam expander 305 that includes first and second lenses 304 and 306. Optical beam generator 300 may also include a half wave plate 307. The optical director 301 may include one or more mirrors 311, 313, and 315. The optical director 301 may further include lenses 321 and 323. The optical director 301 may also include a spatial light modulator 330. The various components described in FIG. 3 are merely examples, and other variations, including eliminating components, combining components, and substituting components are all contemplated.

The optical beam generator 300 may be configured to generate an incoming optical beam 303. The beam splitter 309 may be configured to split the incoming optical beam into two or more optical beams 340 and 342. The optical director 301 may be arranged to direct the two or more optical beams 340 and 342 to overlap at a desired location of fluid on the substrate 350 such that, as also described above, energy generated by the optical beams effectively drives at least some of the nanostructures in the fluid towards the substrate at the location, whereby the nanostructures may be assembled on the substrate by the optical system. The substrate 350 may be implemented using the substrate 210 of FIG. 2. The optical beams 340 and 342 may be implemented using the beams 240 and 242 of FIG. 2. As described above the substrate may include a component, such as an electrical circuit, and a nanowire may be positioned on the electrical circuit responsive to forces generated by the optical beams (e.g., radiation pressure).

The optical beam generator 300 may include a laser 302, a beam expander 305, and a half-wave plate 307. The laser 302 may be configured to generate an optical beam 303. Any suitable laser may be used to provide the laser beam at any suitable power. In one example, infrared lasers may be used. The power of the optical beam 303 provided by the laser 302 may be varied to achieve a desired beam intensity, where the selected beam intensity may be desired to vary the size (or area) of the overlapping location on the substrate. In one example, optical beams may overlap at a location on the substrate having a 0.5 mm diameter when a 1 W infrared laser is used to implement the laser 302. Other lasers may be used to implement the laser 302 including, but not limited to, optical lasers and UV lasers. Example lasers may also include continuous wave lasers, and in some examples pulsed lasers may be used. Other power levels may be used, including less than 1 W in some examples, up to and including 1 W in some examples, up to and including 5 W in some examples, up to and including 10 W in some examples, up to and including SOW in some examples, up to and including 100 W in some examples, and over 100 W in some examples. Example of laser power levels may include 1 W, 2 W, 3 W, 4 W, 5 W, and 6 W in some examples.

The spot size of optical beam 303 may be changed by the beam expander 305. The beam expander 305 may include one or more lenses 304 and 306 configured to change the spot size of the optical beam 303. Other optical devices may also or instead be used including, but not limited to, collimators, galvanometers, or combinations thereof. A half-wave plate 307 and polarizing beam 309 may be arranged in cooperation to together control the relative power levels in each of two split beams (e.g., optical beams 340 and 342). As has been also described above, the relative power levels in each of the optical beams (e.g., two or more optical beams, in some examples) may be adapted to control a predetermined position within the location of overlapping beams on the substrate at which nanostructures may be urged.

The beam splitter 309 may be implemented using any suitable device (e.g., a means for splitting) configured to split an incoming optical beam into multiple beams. In some examples, the beam splitter 309 may be a polarizing beam splitter. In some other examples, the function of the beam splitter may be implemented using multiple optical beam generators instead of or in addition to splitting a single beam from a single optical beam generator.

The optical director may be configured to direct the two optical beams 340 and 342 towards a region of a surface of the substrate 350. The desired location at which nanostructures may be positioned using techniques described herein may or may not be the same as the region where the beams are incident. A portion of the surface of the substrate 350 may have fluid containing nanostructures disposed thereon, as has been described above with reference to the substrate 210 of FIG. 2. The mirrors 311 and 313 may further be implemented as wave plates that are configured to adjust orientation and/or the polarization of the optical beams 340 and 342. The mirror 315 may be configured to reflect the optical beam 342 towards a surface of the substrate 350. A spatial light modulator 330 may be configured to encode a phase pattern in the optical beam 340 and may be further configured to direct the optical beam 340 encoded with the phase pattern towards the surface of the substrate 350. The lenses 321 and 323 may be configured to focus the optical beams 340 and 342, respectively, on the surface of the substrate 350. A diameter of an exit pupil of the spatial light modulator 330 may be varied to selectively change a spot size at a location on the surface of the substrate 350 at which the optical beams 340 and 342 may overlap.

It is to be understood that the particular arrangement of wave plates, mirrors, lenses, beam expander and splitter, and spatial light modulator shown in FIG. 3 is provided by way of example only, and other configurations that result in optical beams directed at the substrate 350 may be used in other examples. Although one spatial light modulator 330 is shown in FIG. 3, in some examples multiple spatial light modulators may be used, including in some examples one spatial light modulator per beam directed onto the substrate 350.

The optical system may further include a dispenser 355. The dispenser 355 may be configured to dispense the fluid onto a surface of the substrate at a desired location. Any suitable fluid dispenser may be used that may employ mechanical, pneumatic, electrical, electro-mechanical, or other forces to spray, deposit, drive, or otherwise dispense fluid about the surface of the substrate 350. Fluid reservoirs may also be coupled to the dispenser 355, where the fluid reservoirs are configured to provide the fluid for the dispenser 355. Multiple dispensers may be provided in other examples.

A controller 360 may further be configured to facilitate the dynamic control/operation of one or more components of the systems described herein. In various examples, controller 360 may be configured in electrical and/or pneumatic or other communication with one or more of the dispenser 355, the optical beam generator 300, the beam splitter 309, and/or the optical director 301. The controller 360 may be configured to control the timing and amount of fluid dispensed from the dispenser 355, for example. The controller 360 may further be configured to selectively control a phase pattern to be provided by the spatial light modulator 330, for example. The controller 360 may also be configured to selectively control a size of an exit pupil of the spatial light modulator 330, for example. The controller 360 may also be configured to selectively control the alignment, position and/or polarization adjustments to be made by one or more of the half wave plate 307, the beam splitter 309, and/or the mirrors 311, 313, or 315, for example.

The optical system of FIG. 3 may further include a motorized translation stage in some examples (not shown in FIG. 3, but described further below). The motorized translation stage may support the substrate 350 and move the substrate to present different surface regions of substrate 350 to the optical beams 340 and 342. The controller 360 may, in some examples, be configured to adaptively control the motorized translation stage.

In other examples, a control system may be operable to control actuators associated with optical components, such as lenses, to move the location over the substrate surface.

While a single controller 360 has been shown in FIG. 3, it is to be understood that the controller 360 may control any combination or subset of parameters described herein, or multiple controllers may be used to control any combination or subset of those parameters. In various examples, a controller 360 may be configured via machine executable instructions that may be provided in the form of hardware based solutions or software based solutions, including but not limited to logic, firmware, software, or combinations thereof.

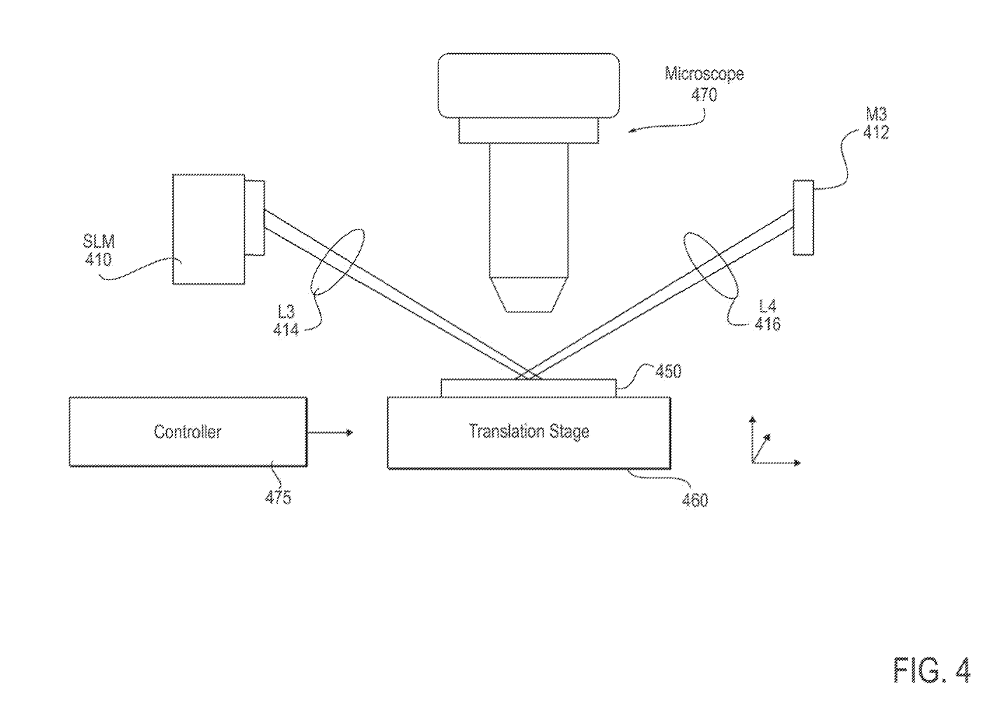

FIG. 4 is a schematic illustration of a portion of an optical system including a translation stage arranged in accordance with at least some examples of the present disclosure. FIG. 4 shows a spatial light modulator 410, a lens 414, a substrate 450, a translation stage 460, a lens 416, a mirror 412, a microscope 470, and a controller 475.

The portion of the optical system includes spatial light modulator 410, which may be implemented using the spatial light modulator 330 of FIG. 3, mirror 412, which may be implemented using the mirror 315 of FIG. 3, and lenses 414 and 416, which may be implemented using the lenses 321 and 323 of FIG. 3. Substrate 450, which may be implemented using the substrate 350 of FIG. 3, may be supported by the translation stage 460. The translation stage 460 may be configured to dynamically move the substrate 450 to present different regions of the surface of the substrate to optical beams.

Microscope 470 may be configured in communication with the spatial light modulator 410 and may be configured to provide feedback to the spatial light modulator 410 to adaptively control a spatial pattern that is incident on the surface of the substrate. The microscope 470 may further be configured to provide a laser beam to the surface of the substrate 450 to, for example, promote bonding of assembled nanowires to the substrate 450. The microscope 470 may further be configured under the control of a controller 475 (which may be implemented by the controller 360 of FIG. 3 in some examples).

In other examples, the optical beams may be directed onto different surface regions of the substrate by dynamically moving the spot location of the optical beams. For example, actuators may be used to move mirrors and/or lenses in an optical system, whereby the location is moved over the surface of the substrate. A galvanometer may also be used to adaptively control the optical beams such that the spot location on the surface of the substrate may be moved.

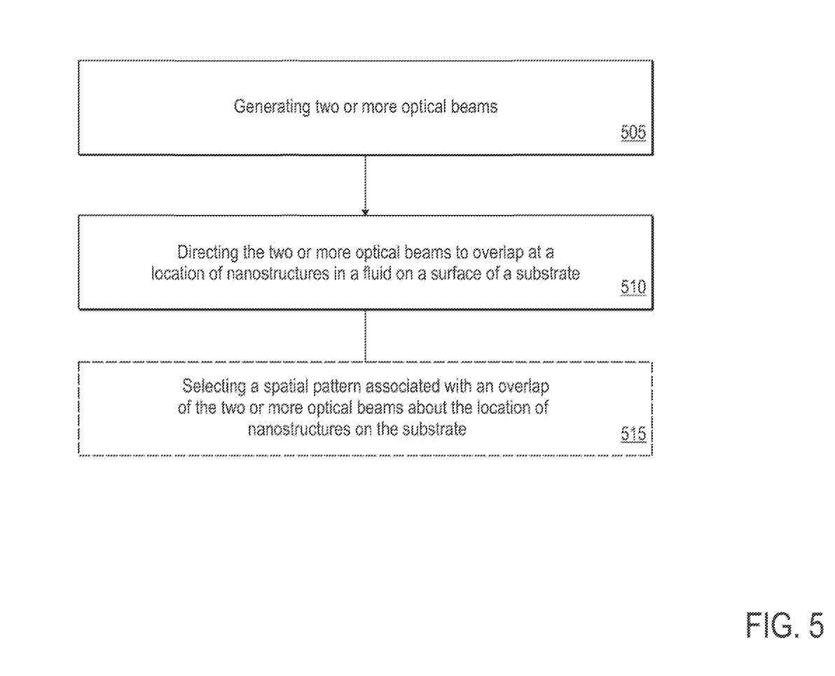

FIG. 5 is a flowchart illustrating an example method for nanostructure assembly arranged in accordance with at least some embodiments of the present disclosure. An example method may include one or more operations, functions or actions as illustrated by one or more of blocks 505, 510, and/or 515. The operations described in the blocks 510 through 515 may be performed in response to execution (such as by one or more processors described herein) of computer-executable instructions stored in a computer-readable medium, such as a computer-readable medium of a computing device or some other controller similarly configured.

An example process may begin with block 505, which recites “generating two or more optical beams.” Block 505 may be followed by block 510, which recites “directing the two or more optical beams to overlap at a location of nanostructures in a fluid on a surface of a substrate.” Block 510 may be followed by block 515, which recites “selecting a spatial pattern associated with an overlap of the two or more optical beams about the location of nanostructures on the substrate.” In this manner, force is applied to the nanostructures and is effective to urge the nanostructures toward a desired location about the substrate. The force may be generated by radiation pressure from the one or more optical beams. Moreover, gradient forces are applied to the nanostructures such that the gradient forces orient the nanostructures in accordance with the spatial pattern.

The blocks included in the described example methods are for illustration purposes. In some embodiments, the blocks may be performed in a different order. In some other embodiments, various blocks may be eliminated. In still other embodiments, carious blocks may be divided into additional blocks, supplemented with other blocks, or combined together into fewer blocks. In some examples, block 510 may occur simultaneously, or at least partially simultaneously, with block 515.

Block 505 recites, “generating two or more optical beams.” Examples of the generation of two or more optical beams has been described above with reference to FIGS. 1-4. Block 510 recites, “directing the two or more optical beams to overlap at a location of nanostructures in a fluid on a surface of a substrate.” Examples of so directing the two or more optical beams have also been described above with reference to FIGS. 1-4.

Block 515 recites, “selecting a spatial pattern [e.g., a diffraction pattern] associated with an overlap of the two or more optical beams about the location of nanostructures on the substrate.” The spatial pattern may be provided, for example, by encoding a phase pattern in one or more of the optical beams using a spatial light modulator, as has been described above with reference to FIGS. 1-4. In other examples, the spatial pattern may be generated in other ways, such as by generating an interference pattern between two or more optical beams or providing a blazed grating. The spatial pattern includes variation in intensity across the location of nanostructures on the substrate. The variation in intensity may cause the nanostructures to align in accordance with the spatial pattern.

In some examples, a controller, such as the controller 360 of FIG. 3, may be used to select and/or adjust the spatial pattern, for example by selecting a phase pattern encoded in one or more of the optical beams by a spatial light modulator. In some examples, the spatial pattern may be selected by applying a phase delay to at least a portion of a spatial light modulator.

To assemble nanostructures across a larger area of a substrate than the location of overlapping beams, the beams may be directed to overlap at a different location and the spatial pattern may be selected at the different location. Alternatively or in addition, as has been described above, the substrate may be moved to expose different regions of the substrate to the overlapping optical beams.

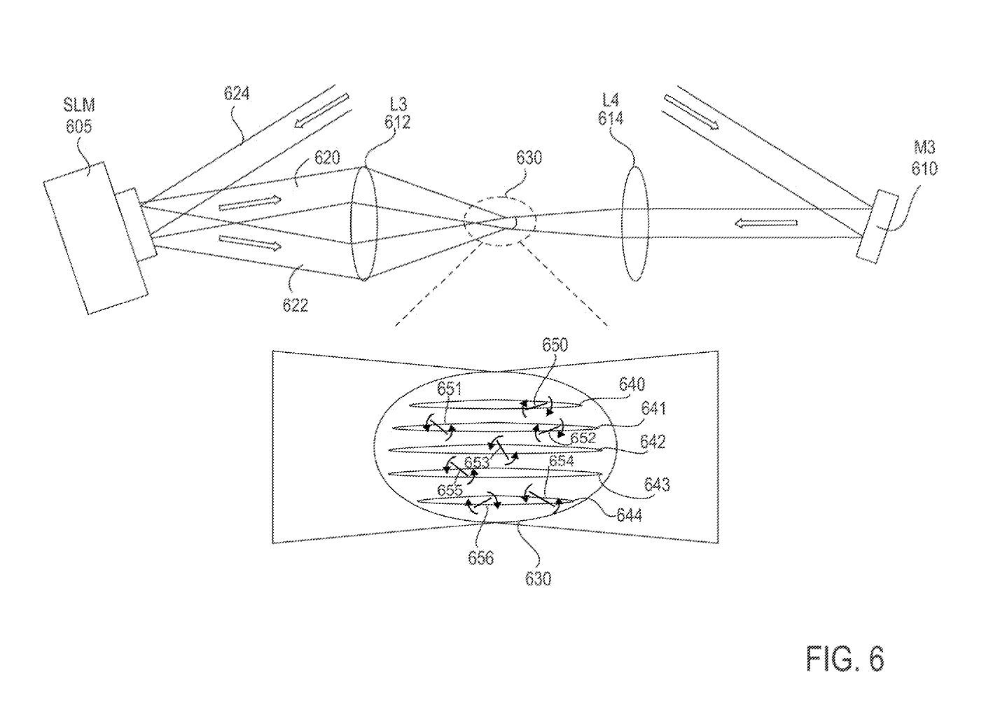

FIG. 6 is a schematic illustration of a portion of an optical system arranged in accordance with at least some embodiments of the present disclosure. The optical system of FIG. 6 includes a spatial light modulator 605, a mirror 610, and lenses 612 and 614. The figure also shows optical beams 624, 620, and 622, and location 630 on the substrate. The lower portion of FIG. 6 shows a top view of a diffraction pattern formed a the location 630, including diffraction maxima (bright fringes) 640, 641, 642, 643, and 644, and nanostructures 650-656 suspended in a fluid at the location.

The spatial light modulator 605 may be implemented using the spatial light modulator 330 of FIG. 3. The mirror 610 may be implemented using the mirror 315 of FIG. 3. The lenses 612 and 614 may be implemented using the lenses 321 and 323 of FIG. 3. In the example of FIG. 6, the spatial light modulator is shown providing a plurality of optical beams 620 and 622 to the lens 612. In other examples, the spatial light modulator may provide a single beam, such as a single beam with a controllable transverse amplitude and/or phase distribution. The lens 612 may focus the plurality of beams onto a location 630 on a substrate. The optical beams 620 and 622 may represent a phase encoded into the optical beam 624 provided to the spatial light modulator. The resulting location 630 may include a diffraction pattern shown in further detail in FIG. 3. The diffraction pattern includes a plurality of diffraction maxima 640-644. The presence of fringes provides gradients in intensity across the location 630. In this manner, a gradient of radiation forces on nanostructures may be provided. Nanowires 650-656 are shown in FIG. 6. The nanowires may feel forces depicted by the arrows in FIG. 6 to align with the diffraction pattern in the location. By selecting the diffraction pattern, accordingly, the orientation of the nanowires may be controlled.

In some examples, an anisotropic nanostructure such as a nanowire may align with a long axis parallel to the local orientation of a diffraction maximum, due to the effect of radiation pressure.

In some examples, an anisotropic nanostructure such as a nanowire may align with a long axis parallel to the local orientation of optical polarization, particularly for linear polarized optical beams. The relative effect of radiation pressure and polarization on the orientation of a nanostructure, such as a nanowire, may depend on nanowire length and other material and local optical parameters. Nanostructures described herein may be utilized in a variety of electronic elements. Examples of active elements which may include nanostructures include, but are not limited to, photodetectors, transistors (such as field effect transistors), diodes, emitters, and optical waveguides. These elements may be combined into functional nanostructure microelectronic circuits or integrated photonic circuits.

Examples of passive elements, which may include nanostructures, include, but are not limited to, elements which utilize physical properties to elicit a bulk material response (e.g., refractive index, reflectivity, birefringence) that may be an average effective response from multiple individual components. Examples include, but are not limited to, broadband anti-reflection coatings for photovoltaic devices, polarization elements for optoelectronics, and thermoelectrics.

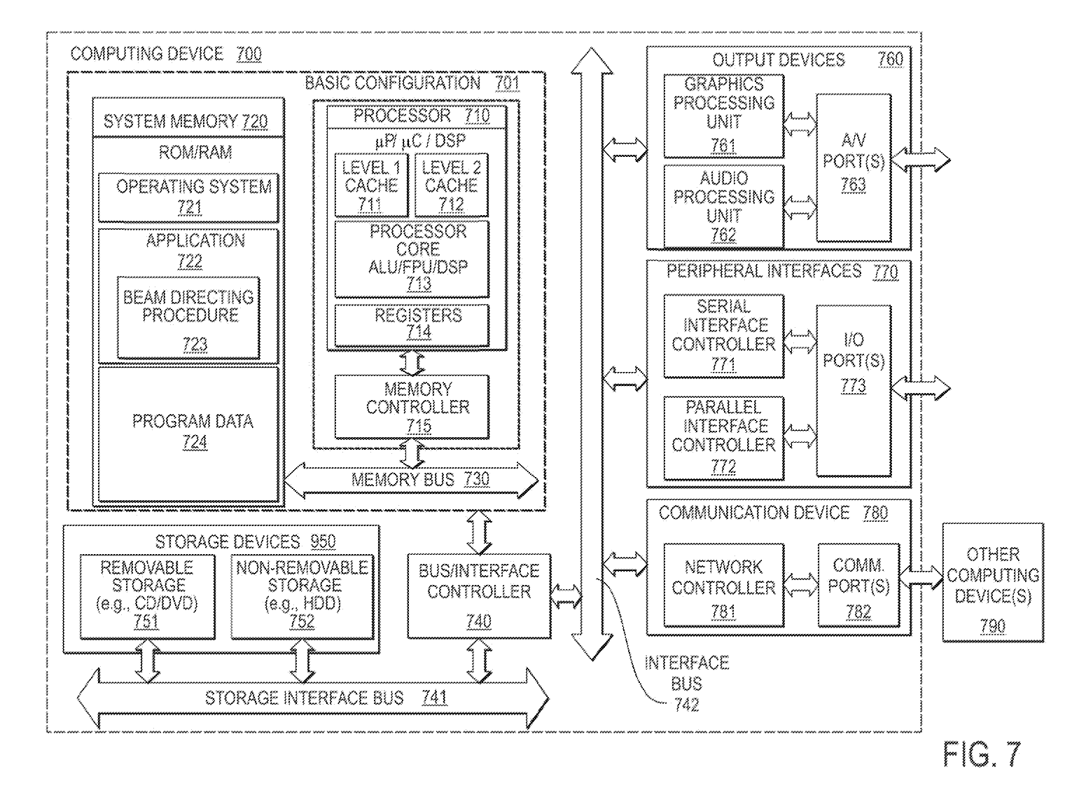

FIG. 7 is a block diagram illustrating an example computing device 700 that is arranged for positioning nanostructures in accordance with the present disclosure. In a very basic configuration 701, computing device 700 typically includes one or more processors 710 and system memory 720. A memory bus 730 may be used for communicating between the processor 710 and the system memory 720.

Depending on the desired configuration, processor 710 may be of any type including but not limited to a microprocessor (raP), a microcontroller (pC), a digital signal processor (DSP), or any combination thereof. Processor 710 may include one more levels of caching, such as a level one cache 711 and a level two cache 712, a processor core 713, and registers 714. An example processor core 713 may include an arithmetic logic unit (ALU), a floating point unit (FPU), a digital signal processing core (DSP Core), or any combination thereof. An example memory controller 715 may also be used with the processor 710, or in some implementations the memory controller 715 may be an internal part of the processor 710.

Depending on the desired configuration, the system memory 720 may be of any type including but not limited to volatile memory (such as RAM), non-volatile memory (such as ROM, flash memory, etc.) or any combination thereof. System memory 720 may include an operating system 721, one or more applications 722, and program data 724. Application 722 may include a beam directing procedure 723 that is arranged to control one or more optical beams and/or substrates as described herein to position nanostructures on a surface of a substrate. Program data 724 may include desired intensities, angles, beam shapes, rastering frequencies, and/or other information useful for the implementation of beam directing for the positioning of nanostructures. In some embodiments, application 722 may be arranged to operate with program data 724 on an operating system 721 such that any of the procedures described herein may be performed. This described basic configuration is illustrated in FIG. 7 by those components within dashed line of the basic configuration 701.

Computing device 700 may have additional features or functionality, and additional interfaces to facilitate communications between the basic configuration 701 and any required devices and interfaces. For example, a bus/interface controller 740 may be used to facilitate communications between the basic configuration 701 and one or more storage devices 750 via a storage interface bus 741. The storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 720, removable storage 751 and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 742 for facilitating communication from various interface devices (e.g., output interfaces, peripheral interfaces, and communication interfaces) to the basic configuration 701 via the bus/interface controller 740. Example output devices 760 include a graphics processing unit 761 and an audio processing unit 762, which may be configured to communicate to various external devices such as a display or speakers via one or more A/V ports 763. Example peripheral interfaces 770 include a serial interface controller 771 or a parallel interface controller 772, which may be configured to communicate with external devices such as input devices (e.g., keyboard, mouse, pen, voice input device, touch input device, etc.) or other peripheral devices (e.g., printer, scanner, etc.) via one or more I/O ports 773. An example communication device 780 includes a network controller 781, which may be arranged to facilitate communications with one or more other computing devices 790 over a network communication link via one or more communication ports 782.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

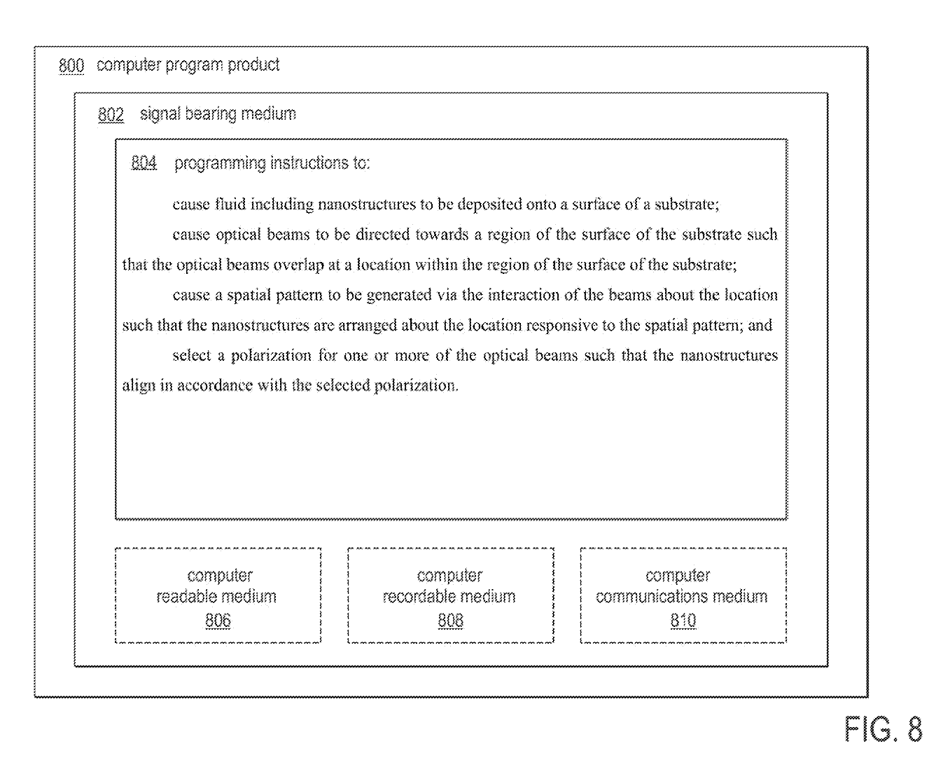

FIG. 8 is a block diagram illustrating an example computer program product 800 that is arranged to store instructions for positioning nanostructures in accordance with the present disclosure. The signal bearing medium 802 which may be implemented as or include a computer-readable medium 806, a computer recordable medium 808, a computer communications medium 810, or combinations thereof, stores programming instructions 804 that may configure the processing unit to perform all or some of the processes previously described. These instructions may include, for example, one or more executable instructions for causing fluid including nanostructures to be deposited onto a surface of a substrate. The instructions may include one or more executable instructions for causing optical beams to be directed towards a region of the surface of the substrate such that the optical beams overlap at a location within the region of the surface of the substrate. The instructions may include one or more executable instructions for causing a spatial pattern to be generated via the interaction of the beams about the location such that the nanostructures are arranged about the location responsive to the spatial pattern. The instructions may include one or more executable instructions for selecting a polarization for one or more of the optical beams such that the nanostructures align about the location in accordance with the selected polarization.

In some embodiments, a method of assembling nanostructures at a desired position comprises directing optical beams towards a fluid including the nanostructures, such that the optical beams overlap at a location within the fluid, which may include, be adjacent to, or be proximate the desired position. A force on one or more nanostructures, resulting from the optical field, may then urge the one or more nanostructures towards the desired position. The location and/or desired position may be proximate, substantially adjacent, or on a surface of a substrate. In some embodiments, the force on one or more nanostructures may be used to create an assembly of nanostructures in the fluid. In some embodiments, the substrate may include an electronic circuit, and the method may be used to direct one or more nanostructures towards predetermined locations, for example relative to other electronic circuit components such as transistors, electrical connections, and the like. Nanostructures may be positioned on the surface of a substrate using forces resulting from the optical beams, and desired positions may be adjusted by adjusting the optical beams. In some examples, a pair of optical beams may be co-planar. In other examples, a pair of optical beams may be non-coplanar. A nanostructure may be positioned on a substrate using forces from the optical field, and then attached to the substrate by any appropriate method, such as a chemical reaction (including photoreactions induced by the optical beams or other light source, or other adhesion or bonding approaches), physical process (such as partial melting), and the like.

In some embodiments, the optical beams may be derived from a single beam, for example using a beamsplitter to split the single beam (such as a laser beam) into one or more beams that are then directed to overlap at a desired location. The intensity and direction of the optical beams may be adjusted to locate a plurality of nanostructures at one or more desired locations. In some embodiments, forces may arise due to an interaction between the electrical field portion of an electromagnetic field and electrical properties of the nanostructures, such as dielectric or polarizability anisotropy. In some examples, a nanostructure may be partially aligned and/or urged in a direction by, for example, an additional electric field, magnetic field, anisotropic liquid (such as a nematic liquid crystal), or other field or process prior to, after, or during the efect of the forces due to the optical field,

In some embodiments, the nanostructure may be a nanowire, such as a metal nanowire or a semiconductor nanowire. Assembly of the nanostructures may include assembly of an electronic component including the nanostructure, such as an optical sensor, light emitting diode out-coupler, and the like. In some embodiments, methods may include scalable self-assembly of semiconductor or metallic nanowires, where the nanowires may be dynamically configured onto a substrate using large area dynamic optical micromanipulation. Example methods may be combined with other electronic device assembly methods, for example to electrically connect a located nanowire to proximate components, and may be used as a post-processing approach after chip scale integration is complete. Nanowires may be functionalized, for example for biosensor or other sensor applications. Example methods include the assembly of electronic devices, optical devices, electrooptical devices, and integrated circuits (such as integrated photonic circuits) including such devices. In some embodiments, an antireflection (AR) coating may be deposited on a substrate, and in some examples the AR coating may be patterned by appropriate adjustment of the optical beams.

In some embodiments, methods may include controlling the orientation and/or location of nanostructures (such as nanowires, and the like) by adjusting parameters of one or more optical beams, such as beam intensity, location of the overlap region (for example by adjusting the location(s) of beam incidence on the substrate), beam angle relative to the substrate (in one or more planes, for example by adjusting incidence and/or azimuth angle(s)), and the like. Nanostructures may be registered with existing circuitry on a substrate.

In some embodiments, counter-propagating beams, such as laser beams, are directed towards a substrate. In some examples, an angle between each beam and the substrate is approximately equal for each beam. In some examples the angle is less than 45 degrees for each optical beam, and in some examples may be a near grazing incidence. In some embodiments, the beams may be focused so that a higher intensity is obtained in the overlap region, but in some embodiments the beams are not focused and may be generally parallel beams. In some examples, beams may be expanded to increase the overlap region. In some embodiments, forces in the region where the beams overlap urge nanostructures in the overlap region towards the center of the overlap region, for example through the effects of radiation pressure. Forces may also urge the nanostructures towards a substrate surface, for example where the beam direction includes a component directed towards the surface. In some examples, forces such as radiation pressure may be greatly enhanced due to the relative refractive indices involved. For example, the refractive index of semiconductor nanostructures (e.g. n=3.6 for silicon) may be much larger than standard dielectric particles (e.g. n=1.45 for silica). As radiation pressure increases with the refractive index mismatch between the object and surrounding medium (e.g. n=1.33), the forces may be larger.

In some embodiments, an assembly method for assembling one or more nanostructures at a desired location on a surface of a substrate comprises: depositing a fluid including a plurality of nanostructures on the surface of the substrate, the plurality of nanostructures including the one or more nanostructures; directing optical beams towards the surface of the substrate such that the optical beams overlap adjacent the desired location; and urging the one or more nanostructures towards the desired location with force(s) generated by the optical beams, such that the one or more nanostructures are assembled at the desired location on the surface of the substrate.

In some embodiments, an assembly method for assembling one or more nanostructures at a desired location on a surface of a substrate comprises: depositing a fluid including a plurality of nanostructures on the surface of the substrate, the plurality of nanostructures including the one or more nanostructures; directing optical beams towards the surface of the substrate such that the optical beams overlap adjacent the desired location so as to urge the one or more nanostructures towards the desired location. In some embodiments, an assembly method may further comprise adjusting one or more beam parameters of one or more of the optical beams to move the desired location to a second desired location, or otherwise modify forces on the nanostructures. Beam parameters may include one or more of the following beam parameters: intensity, phase, frequency, polarization, and cross-sectional spatial modulation (for example as may be achieved using a spatial light modulator).

In some embodiments, an assembly method comprises depositing a fluid suspension of nanostructures on a surface, and directing optical beams towards the surface such that the optical beams overlap within the fluid suspension of nanostructures and generate a force on each of one or more nanostructures (due to an interaction between the optical field in the overlap region and each of the one or more nanostructures) that urges the one or more nanostructures towards the surface. The one or more nanostructures may be positioned at one or more desired locations on a surface of the substrate using, for example, radiation pressure and/or other forces generated by the optical beams where they overlap.

In some embodiments, a method for nanowire assembly comprises generating two or more optical beams: directing the two or more optical beams to overlap at a location of nanostructures in a fluid on a surface of a substrate; selecting a spatial pattern associated with an overlap of the two or more optical beams about the location of nanostructures on the substrate, wherein force is applied to the nanostructures effective to urge the nanostructures toward a desired location about the substrate, and gradient forces are applied to the nanostructures such that the gradient forces orient the nanostructures in accordance with the spatial pattern. Adjusting a spatial pattern may comprise utilizing a controller to adjust the spatial pattern. In some examples, a method for nanowire assembly comprises directing the two or more optical beams to overlap at a different location, and selecting the diffraction pattern associated with the overlap of the two or more optical beams about the different location of nanostructures on the surface of the substrate. In some examples, a method for nanowire assembly may comprise increasing an intensity of one or more of the optical beams to adhere the nanostructures to the surface of the substrate. In some examples, a method may comprise applying a phase delay to at least a portion of a spatial light modulator to adjust the spatial pattern. In some examples, the nanostructures may comprise carbon nanotubes, metal nanowires, and the like.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. It is to be understood that this disclosure is not limited to particular methods, reagents, compounds compositions or biological systems, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

While the foregoing detailed description has set forth various examples of the devices and/or processes via the use of block diagrams, flowcharts, and/or examples, such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the examples disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. For example, if a user determines that speed and accuracy are paramount, the user may opt for a mainly hardware and/or firmware vehicle; if flexibility is paramount, the user may opt for a mainly software implementation; or, yet again alternatively, the user may opt for some combination of hardware, software, and/or firmware.

In addition, those skilled in the art will appreciate that the mechanisms of the subject matter described herein are capable of being distributed as a program product in a variety of forms, and that an illustrative example of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

What is claimed is:

1. An assembly method, the method comprising:
depositing fluid including nanostructures onto a surface of a substrate;
directing optical beams towards a region of the surface of the substrate such that the optical beams overlap at a location within the region of the surface; and
urging one or more nanostructures of the nanostructures in the fluid towards a desired location on the surface of the substrate with a force generated by the optical beams within the region, such that the one or more nanostructures are arranged on the substrate at the desired location.

2. The method of claim 1, wherein depositing fluid further comprises depositing fluid that includes one or more of nanowires in a suspension, nanorods in the suspension, and nanodisks in the suspension.

3. The method of claim 1, wherein directing optical beams comprises:
directing a first optical beam to a first point within the region; and
directing a second optical beam to a second point within the region;
wherein the first and second optical beams overlap at the location within the region of the surface of the substrate.

4. The method of claim 1 wherein directing optical beams comprises:
focusing a first optical beam to a first point within the region; and
focusing a second optical beam to a second point within the region;
wherein the first and second optical beams overlap at the location within the region of the surface of the substrate.

5. The method of claim 1, wherein the radiation pressure generated by the optical beams further effectively urges at least some of the nanowires in the fluid toward a predetermined position within the location, wherein the predetermined position is based, at least in part, on respective intensities of the optical beams.

6. The method of claim 1, wherein directing optical beams further comprises directing the optical beams to substantially converge at a central position about the location.

7. The method of claim 1, wherein directing optical beams further comprises directing optical beams of equal intensity.

8. The method of claim 1, wherein depositing fluid including nanostructures further comprises depositing fluid including metal nanostructures.

9. The method of claim 1, wherein depositing fluid including nanostructures further comprises depositing fluid including semiconductor nanostructures.

10. The method of claim 1, wherein depositing fluid including nanostructures further comprises depositing fluid including electrically conductive nanostructures.

11. The method of claim 1, wherein depositing fluid including nanostructures further comprises depositing fluid including electrically insulating nanostructures.

12. The method of claim 1, wherein depositing fluid including nanostructures further comprises depositing fluid including dielectric nanostructures.

13. The method of claim 1, further comprising generating a spatial pattern via the interaction of the beams about the location where the optical beams overlap such that the nanostructures are arranged about the location responsive to the spatial pattern.

14. The method of claim 13, wherein generating the spatial pattern comprises adjusting a phase delay of one or more of the optical beams to adaptively control the spatial pattern.

15. The method of claim 13, wherein generating the spatial pattern comprises encoding a phase pattern in one or more of the optical beams.

16. The method of claim 15, wherein encoding the phase pattern comprises varying a phase delay across a cross-section of one or more of the optical beams.

17. The method of claim 1, further comprising selecting a polarization for one or more of the optical beams such that the nanostructures align about the location in accordance with selected polarization.

18. The method of claim 1, wherein directing the optical beams comprises focusing the optical beams at an oblique angle with respect to a surface of the substrate.

19. The method of claim 1, further comprising removing the fluid from the substrate after the nanostructures are assembled on the substrate.

20. An optical system configured to assemble nanostructures from a fluid on a surface of a substrate, the optical system comprising:
an optical director arranged to:
direct a first optical beam towards a region of the surface of the substrate;
direct a second optical beam towards the region of the surface of the substrate such that the first and second optical beams overlap at a location within the region of the surface such that radiation pressure generated by the optical beams effectively drives at least some of the nanostructures in the fluid towards the substrate at the location, whereby the nanostructures are assembled on the substrate by the optical system.

21. The optical system of claim 20 further comprising a dispenser configured to dispense the fluid onto the substrate at the location.

22. The optical system of claim 20 further comprising a half wave plate configured to control relative power in the two optical beams.

23. The optical system of claim 20, wherein the radiation pressure generated by the optical beams effectively drives at least some of the nanostructures in the fluid towards a predetermined position within the location, wherein the predetermined position is based, at least in part, on respective intensities of the optical beams.

24. The optical system of claim 20 further comprising:
a spatial light modulator configured to encode a phase pattern in one or more of the optical beams.

25. The optical system of claim 24, wherein a size of the location is based, at least in part, on a diameter of an exit pupil of the spatial light modulator.

26. The optical system of claim 20 further comprising a beam expander configured to shape the incoming optical beam.

27. The optical system of claim 20 further comprising a laser configured to generate the incoming optical beam.

28. The optical system of claim 20 further comprising a motorized translation stage configured to support the substrate and configured to move the substrate to present different substrate regions to the optical beams.

29. The optical system of claim 20, wherein the substrate comprises an electrical circuit and wherein a nanostructure is assembled on the electrical circuit responsive to the radiation pressure.

30. The optical system of claim 20, wherein the nanostructures comprise nanowires having an aspect ratio equal to or greater than 10:1.

31. The optical system of claim 20, wherein the nanostructures comprise nanowires including gallium arsenide nanowires.

32. A method for nanowire assembly, the method comprising:
generating two or more optical beams;
directing the two or more optical beams to overlap at a location of nanostructures in a fluid on a surface of a substrate;
selecting a spatial pattern associated with an overlap of the two or more optical beams about the location of nanostructures on the substrate, wherein force is applied to the nanostructures effective to urge the nanostructures toward a desired location about the substrate, and gradient forces are applied to the nanostructures such that the gradient forces orient the nanostructures in accordance with the spatial pattern.
